(19) United States
(12) Patent Application Publication
(10) Pub. No.: US 2006/0017981 A1
(43) Pub. Date: Jan. 26, 2006

(54) Film bridge assembly for a digital film scanning system

(75) Inventors: Jason McPeak, Austin, TX (US); Dung T. Duong, Austin, TX (US); William D. Mapel, Liberty Hill, TX (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/894,604

(22) Filed: Jul. 20, 2004

(51) Int. Cl. H04N 1/23

(52) U.S. Cl. 358/302; 358/474

(57) ABSTRACT

A film bridge assembly adapted to precisely position film during scanning in a digital film processing system. The film bridge assembly makes up part of a film bridge and illuminator cavity system that includes a slot for the passage of illumination light that is used to scan film at an opening of the slot. A window or cylindrical lens is provided at the opening of the slot to permit film to pass over the slot without incurring any scratching. The window or lens is effective to keep the film at a constant height, reduce debris at the image plane, and permit a maximum amount of illumination light to pass through the film.

### FIELD OF THE INVENTION

The present invention relates generally to film scanning, and more particularly to a film bridge for use in the transportation and scanning of film in a film scanning system.

### BACKGROUND OF THE INVENTION

Color photographic film generally comprises three layers of light sensitive material that are separately sensitive to red, green, and blue light. During conventional color photographic film development, the exposed film is chemically processed to produce dyes in the three layers with color densities directly proportional to the blue, green and red spectral exposures that were recorded on the film in response to the light reflecting from the photographed scene. Yellow dye is produced in the top layer, magenta dye in the middle layer, and cyan dye in the bottom layer, the combination of the produced dyes revealing the latent image. Once the film is developed, a separate printing process can be used to record photographic prints, using the developed film and photographic paper.

In contrast to conventional film development, digital film development systems, or digital film processing (DFP) systems, have been proposed. One such system involves chemically developing exposed film to form scene images comprised of silver metal particles or grains in each of the red, green, and blue recording layers of the film. Then, while the film is developing, it is scanned using electromagnetic radiation, such as light with one predominant frequency, for example, in the infrared region. In particular, as the film develops in response to chemical developer, a light source is directed to the front of the film, and/or a light source is directed to the back of the film. Grains of elemental silver developing in the top layer (e.g., the blue sensitive layer) are visible from the front of the film by light reflected from the front source; however, these grains are substantially hidden from the back of the film. Similarly, grains of elemental silver developing in the bottom layer (e.g., the red sensitive layer) are visible from the back of the film by light reflected from the back source; however these grains are substantially hidden from the front. Meanwhile, grains of elemental silver in the middle layer (e.g., the green sensitive layer) are substantially hidden from the light reflected from the front or back; however, these grains are visible by any light transmitted through the three layers, as are those grains in the other two layers. Thus, by sensing, for each pixel location, light reflected from the front of the film, light reflected from the back of the film, and light transmitted through the film, three measurements can be acquired for each pixel. The three measured numbers for each pixel can then be solved for the three colors to arrive at three color code values for each pixel, and the plurality of colored pixels can then be printed or displayed to view the image.

If desired, such scanning of each frame on the film can occur at multiple times during the development of the film. Accordingly, features of the frame that may appear quickly during development can be recorded, as well as features of the frame that may not appear until later in the film development. The multiple digital image files for each frame can then be combined to form a single enhanced image file.

In another such digital film processing (DFP) system, a developer solution is applied to the film and dyes form on the film. As the film is developing via the applied solution, visible light and/or infrared light are applied to one side of the film. On the opposite side of the film, a sensor detects the light passing through the film and produces a digital representation of the image developing on the film.

With these and other digital film processing and scanning systems, the film can be moved across a scanning area, and the radiation can be applied to the scanning area to obtain the image data. A film bridge or similar support mechanism can be utilized to control the position of the film as it passes over the scanning area. For optimum accuracy in scanning of the film, the positioning of the film should be tightly controlled. In particular, vertical vibration and movement of the film should be avoided as such movements can jolt the film out of the focus of the optics, resulting in unfocused image data. Moreover, the film should remain substantially flat across the imaging area in order to obtain accurate results. In addition, the mechanisms used to transport and control the position of the film during scanning should avoid imparting scratches or other physical defects to the image area of the film, as such scratches and defects can result in an inferior digital image.

It is further advantageous to keep the film as close to the illumination cavity as possible. This produces the maximum illumination intensity through the film.

A conventional film bridge and illumination assembly or device is shown in FIG. 1. Illumination device 30 is in the form of an illumination cavity that includes a first member 30a and a second member 30b. First and second members 30a and 30b define a slot 32 there-between for the passage of illumination light or radiation from a light source 10 to an opening 34 of slot 32. During scanning, film 14 is slid in direction 16 over slot opening 34 while illumination 36 from light source 10 passes through film 14. The design of FIG. 1 has several drawbacks. First, pulling film across a metallic or plastic material tends to induce scratches that reduce scanned image quality. The debris from the scratches and other areas of the machine also tends to get trapped on an area of the trailing edge of the slot (shown in general by reference numeral 40 in FIG. 1) that also causes scanning problems. This debris can eventually fall into the illumination cavity. The scratching is lessened when the film tension is reduced but this causes flatness and focus irregularities with the film that leads to poor image quality.

### SUMMARY OF THE INVENTION

The present invention relates to a method and apparatus in which the magnitude and frequency of defects that are applied to the film during film transportation and scanning are reduced. More specifically, the invention provides for a film bridge design that reduces or eliminates film scratching and reduces the susceptibility of film to debris to prevent defects to the image.

The present invention further provides for a film bridge that is adapted to maintain the film in a flat state at a constant height, while at the same time permitting the application of a desired illumination intensity through the film.

The present invention therefore provides for a film bridge assembly for a film scanning system which comprises: a first bridge member having a first film facing surface; a second bridge member having a second film facing surface, with the first and second bridge members being spaced from each other to define a slot there-between that provides for a passage of illumination light from an opening of the slot through film traveling across the film bridge along a film path; and a cylindrical lens provided on the opening and extending between the first film facing surface and the second film facing surface, such that the film traveling across the film bridge contacts the cylindrical lens at or near an apex of the cylindrical lens and does not contact opposing edges of the cylindrical lens on each side of the apex.

The present invention further relates to a method of scanning film which comprises the steps of: locating a first bridge member having a first film facing surface and a second bridge member having a second film facing surface relative to each other so as to define a slot there-between that provides for a passage of illumination light from an opening of the slot through film traveling across the film bridge along a film path; providing a cylindrical lens on the opening so as to extend between the first film facing surface and the second film facing surface; and transporting film to be scanned across the film bridge in manner in which the film contacts the cylindrical lens at or near an apex of the cylindrical lens and does not contact opposing edges of the cylindrical lens on each side of the apex.

Another embodiment of the invention is to utilize the cylindrical lens at a shoe. The cylindrical lens could be placed just before or after the illumination slot to provide a shoe which the film slides over thereby maintaining a small gap from the illumination slot to the film. The shoe concept could be applied using single shoe before of after the illumination slot or to a dual concept with each part straddling the illumination slot.

The present invention therefore further relates to a film bridge assembly for a film scanning system which comprises a first bridge member having a first film-facing surface; a second bridge member having a second film facing surface, with the first and second bridge members being spaced from each other to define a slot there-between that provides for a passage of illumination light from an opening of the slot through film traveling across the film bridge along a film path; and a cylindrical part provided on one of the first or second film facing surfaces, such that the cylindrical part maintains a gap between film traveling across the cylindrical part and the opening from the slot.

### BRIEF DESCRIPTION OF THE DRAWINGS

FIG. 1 is a schematic view of a related illumination device and film bridge;

FIG. 2 is a schematic view of a digital film processing or development system that can be used in the present invention;

FIG. 3 is a view of a film bridge and illumination device in accordance with a first embodiment of the present invention;

FIG. 4 is a detailed view of the film bridge of FIG. 3;

FIG. 5 is a view of a film bridge in accordance with a second embodiment of the present invention; and

FIG. 6 is a perspective view of the film bridge and illumination device in accordance with the present invention;

FIG. 7 is a view of a film bridge and illumination device in accordance with a further embodiment of the present invention;

FIG. 8 a view of a film bridge and illumination device in accordance with a still further embodiment of the present invention; and

FIG. 9 a view of a film bridge and illumination device in accordance with a still further embodiment of the present invention.

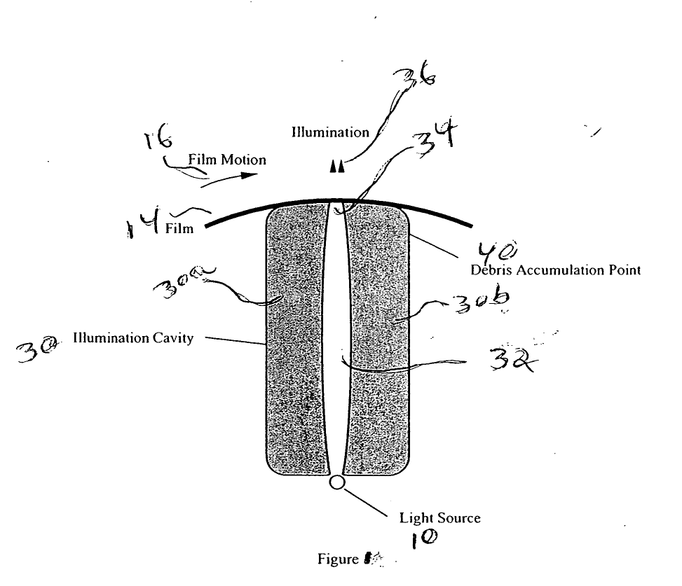

### DETAILED DESCRIPTION OF THE INVENTION

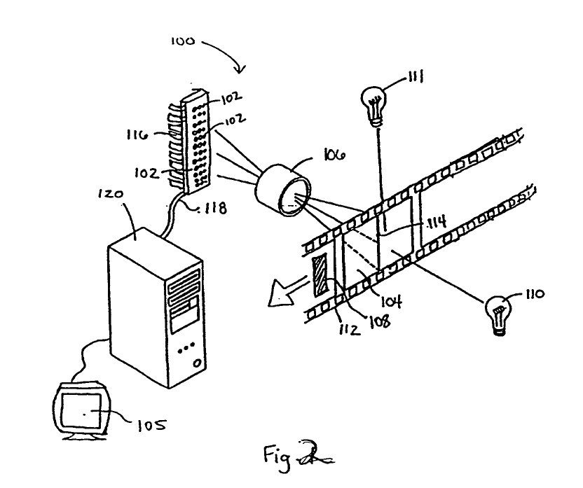

Referring now to the drawings, wherein like reference numerals represent identical or corresponding parts throughout the several views, FIG. 2 shows an exemplary digital film processing system (DFP) 100. The system operates by converting electromagnetic radiation from an image to an electronic (digital) representation of the image. The image being scanned is typically provided on a photographic film media 112 that is being developed using chemical developer. In some applications, the electromagnetic radiation used to convert the image into a digital representation is infrared light; however, visible light, microwave and other suitable types of electromagnetic radiation may also be used to produce the digitized image. The scanning system 100 generally includes a number of optic sensors 102, which measure the intensity of electromagnetic energy passing through or reflected by the developing film 112. The source of electromagnetic energy is typically a light source 110 that illuminates the film 112 containing the scene image 104 and 108 to be scanned, which are forming on the film during the film development. Radiation from the source 110 may be diffused or directed by additional optics such as filters or waveguides (not shown) and/or one or more lenses 106 positioned between the sensor 102 and the film 112 in order to illuminate the images 104 and 108 more uniformly.

Source 110 is positioned on the side of the film 112 opposite the optic sensors 102. This placement results in sensors 102 detecting radiation emitted from source 110 as it passes through the images 104 and 108 on the film 112. Another radiation source 111 can be placed on the same side of the film 112 as the sensors 102. When source 110 is activated, sensors 102 detect radiation reflected by the images 104 and 108. The process of using two sources positioned on opposite sides of the film being scanned is referred to as duplex scanning.

The optic sensors 102 are generally geometrically positioned in arrays such that the electromagnetic energy striking each optical sensor 102 corresponds to a distinct location 114 in the image 104. Accordingly, each distinct location 114 in the scene image 104 corresponds to a distinct location, referred to as a picture element, or “pixel” for short, in a scanned image, or digital image file, which comprises a plurality of pixel data. The images 104 and 108 on film 112 can be sequentially moved, or scanned relative to the optical sensors 102. The optical sensors 102 are typically housed in a circuit package or unit 116 which is electrically connected, such as by cable 118, to supporting electronics for storage and digital image processing, shown together as computer 120. Computer 120 can then process the digital image data and display it on output device 105. Alternatively, computer 120 can be replaced with a microprocessor or controller and cable 118 replaced with an electrical connection.

Optical sensors 102 may be manufactured from different materials and by different processes to detect electromagnetic radiation in varying parts and bandwidths of the electromagnetic spectrum. For instance, the optical sensor 102 can comprise a photodetector that produces an electrical signal proportional to the intensity of electromagnetic energy striking the photodetector. Accordingly, the photodetector measures the intensity of electromagnetic radiation attenuated by the images 104 and 108 on film 112.

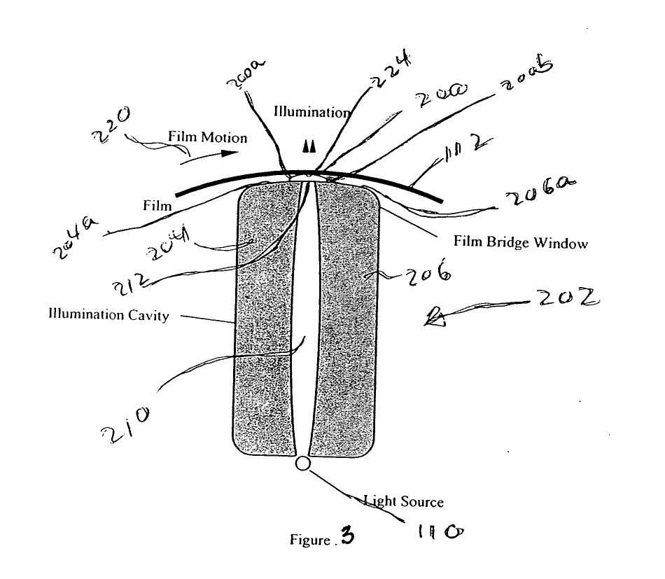

As discussed above, in order to scan film 112, it is preferred that film 112 travel across a film bridge A film bridge assembly for a scanning system in accordance with the present invention is shown in FIG. 3. More specifically, a film bridge assembly 202 which makes up part of an illumination system comprises a part, window or lens 200, preferably in the form of a cylindrical lens or part. As illustrated in FIG. 3, a film bridge assembly 202 includes a first bridge member 204 having a first film facing surface 204a, and a second bridge member 206 having a second film facing surface 206a. The first and second bridge members (204, 206) are spaced from each other to define a slot or cavity 210 there-between that provides for a passage of illumination light through an opening 212 of slot 210; with the light thereafter passing through lens 200 and film 112 traveling across the film bridge along a film path. The illumination light is provided by light source 110 located at an entrance to slot 210.

Cylindrical lens 200 is provided on the opening 212 so as to extend between the first film facing surface 204a and the second film facing surface 206a. Therefore, the film 112 traveling across the film bridge in direction 220 contacts the cylindrical lens 200 at or near an apex 224 of the cylindrical lens 200 and does not contact opposing edges 200a, 200b of the cylindrical lens 200 on each side of the apex 224. Therefore, the contact patch or the amount of contact between the window and the film is minimized with this geometry, thus keeping the film as flat as possible, eliminating window or lens edge scratching of the film, and minimizing the accumulation of debris.

It is preferred that the material for the cylindrical lens 200 be very hard in order to avoid scratching. The preferred materials are Sapphire and Diamond although any visibly clear hard material can also be used. The cylindrical lens 200 should be manufactured with minimum thickness to minimize illumination loss.

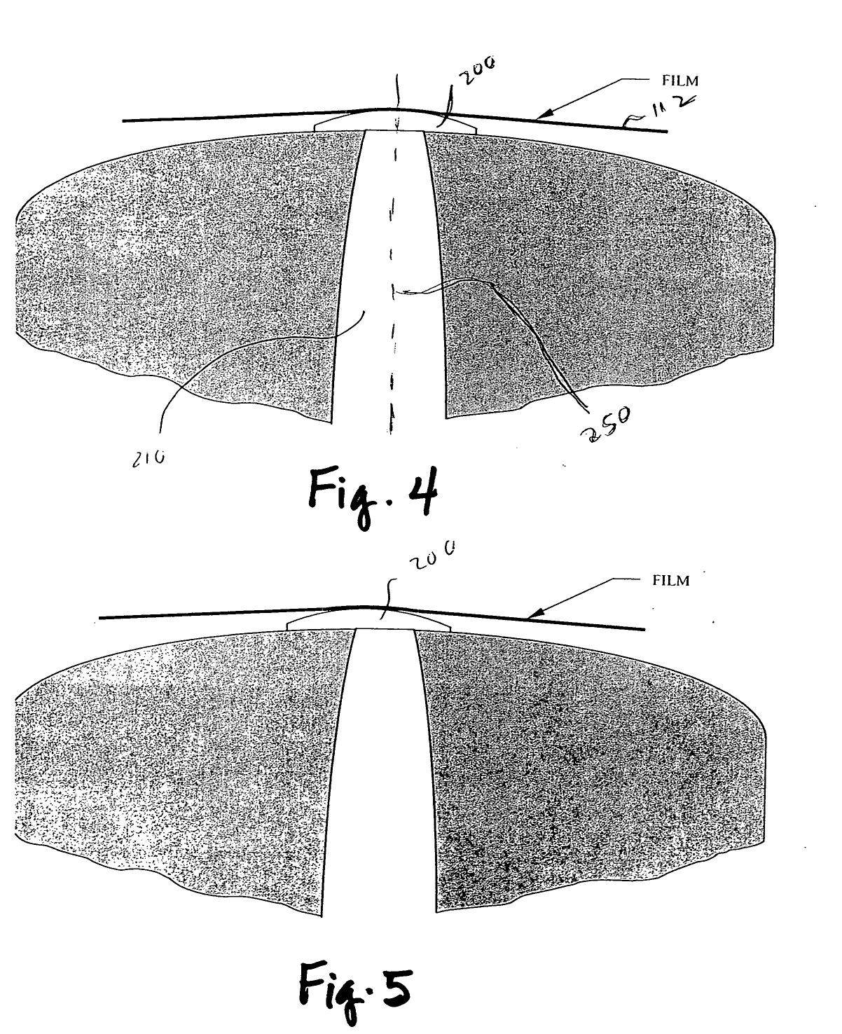

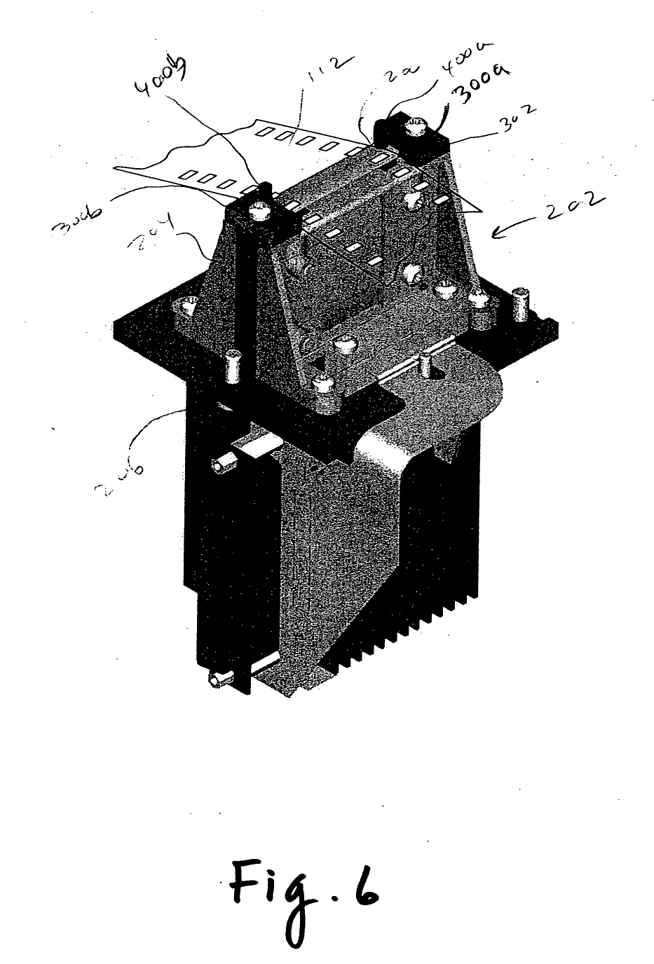

As shown in FIG. 4, reference numeral 250 identifies a longitudinal axis that extends along the center of slot 210. In a first feature of the present invention, lens 200 may be centered on the opening 212 relative to axis 250. In a further option as shown in FIG. 5, lens 200 can be located on opening 212 in a manner in which lens 200 is offset relative to axis 250. Locating lens 200 in an offset manner as shown in FIG. 5 provides for an extra degree of freedom that allows an illumination pattern to be optimized for the individual scanner design. Final geometry of the window or lens depends on several factors. The window or lens thickness should be minimized for maximum illumination throughput. Additional window or lens dimensions are dependant on fabrication technique, window or lens material, film entrance and egress angles and illuminator cavity or slot size.

FIG. 6 is a perspective view of film bridge assembly 202. In a feature of the present invention, the mounting of window or lens 200 can be based on several factors. A compliant mount is dictated by the fragile nature of a thin window or lens. In addition, the mounting should address film guiding features, stray light control, and maintenance. FIG. 6 illustrates an embodiment and method of window mounting. In the design of FIG. 6, cylindrical lens 200 is held down with clamps 300a and 300b provided on opposing sides of lens 200, as well as the opposing sides of the film path for film 112. In a feature of the invention, a compliant material 302 (foam or rubber) can be provided between each clamp 300a, 300b and the lens 200 so as to contact lens 200. This prevents damage to the lens 200 while at the same time holding the lens 200 at the opening 212 of cavity 210. In a further feature of the invention as shown in FIG. 6, clamps 300a, 300b can be accurately located by hardened dowel pins 400a and 400b. Pins 400a, 400b serve as location features for the clamps 300a, 300b that hold down the lens 200. Further, by positioning pins 400a and 400b on opposing sides of the film path as shown in FIG. 6, the pins 400a, 400b serve as film guides to guide film 112 along the film path.

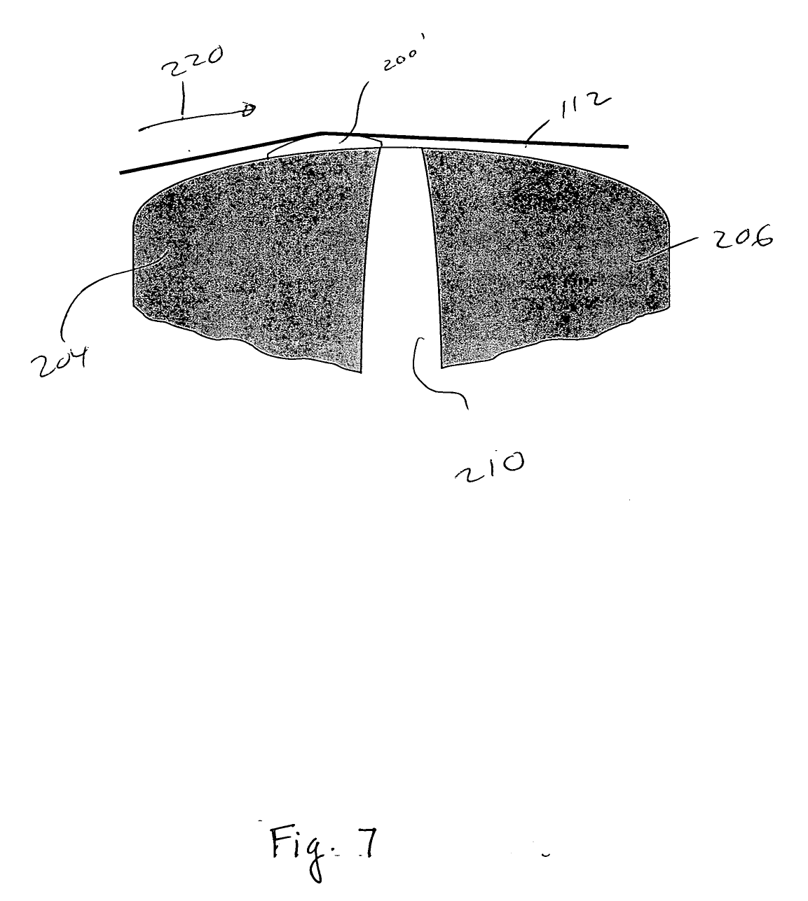

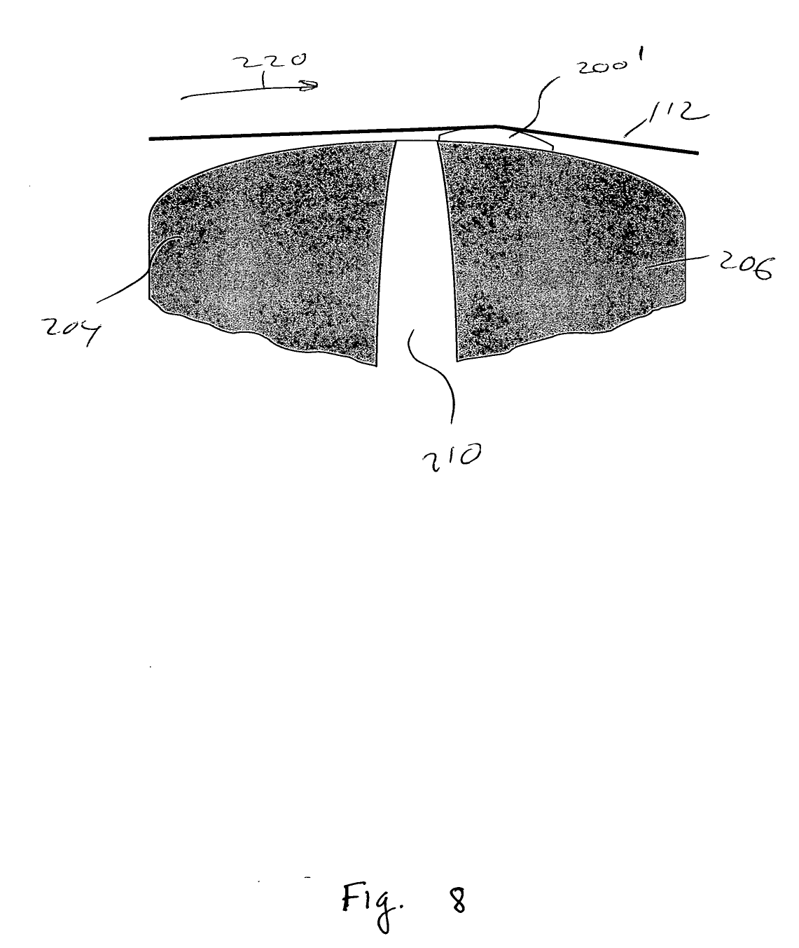

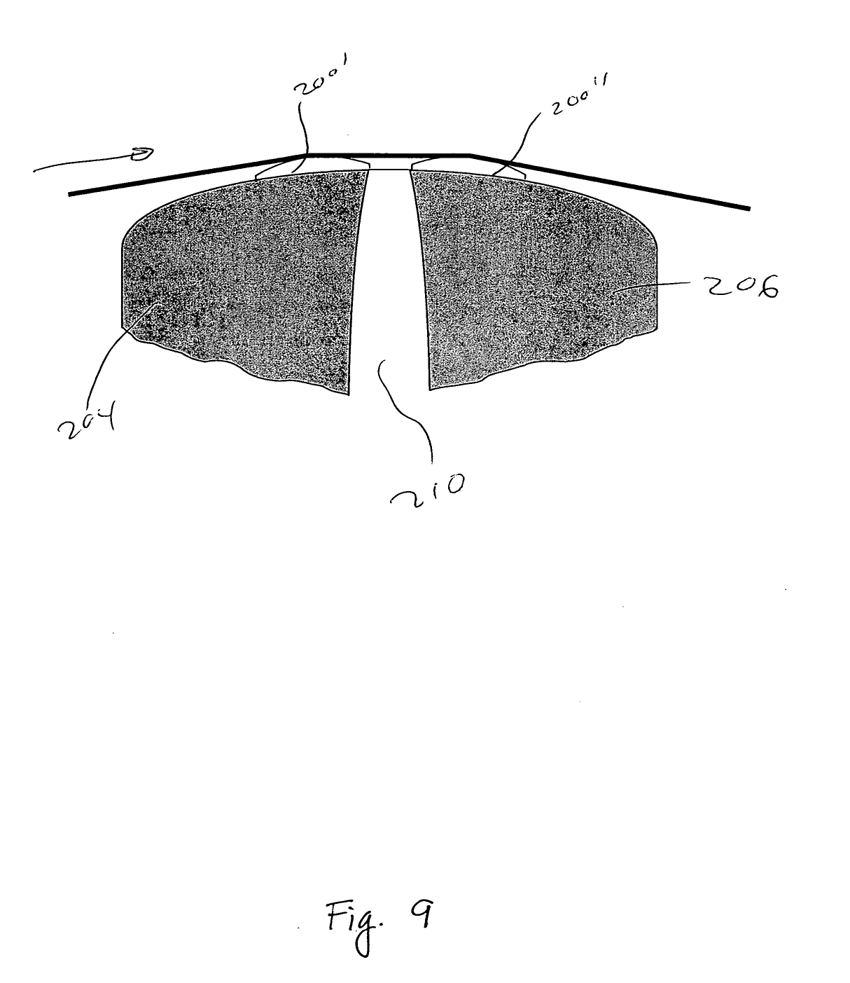

Additionally, a cylindrical lens or part 200′ could be used as a shoe instead of a window as shown in FIG. 7. Cylindrical part 200′ does not have to be clear or optical in this embodiment since it simply acts as a film shoe that does not scratch film and will not wear. It is desirable for cylindrical part 200′ to be as thin as possible to maximize the amount of light from illumination slot 210 onto the the film. The cylindrical part 200′ may be located prior to illumination slot 210 (FIG. 7) or on the trailing side of illumination slot 210 as shown in FIG. 8. Additionally the film bridge assembly could utilize dual cylindrical parts 200′, 200″ as shown in FIG. 9. In the embodiments noted above, the cylindrical parts 200, 200′ or 200″ are adapted to maintain a small gap from the illumination slot to the film.

The invention has been described in detail with particular reference to certain preferred embodiments thereof, but it will be understood that variations and modifications can be effected within the spirit and scope of the invention.

1. A film bridge assembly for a film scanning system, the film bridge assembly comprising:
a first bridge member having a first film-facing surface;
a second bridge member having a second film facing surface, the first and second bridge members being spaced from each other to define a slot there-between that provides for a passage of illumination light from an opening of said slot through film traveling across the film bridge along a film path; and
a cylindrical lens provided on said opening and extending between the first film facing surface and the second film facing surface, such that the film traveling across the film bridge contacts said cylindrical lens at or near an apex of the cylindrical lens and does not contact opposing edges of said cylindrical lens on each side of said apex.

2. A film bridge assembly according to claim 1, wherein the cylindrical lens is centered on said opening.

3. A film bridge assembly according to claim 1, wherein a central longitudinal axis is defined along a center of said slot and said cylindrical lens is provided on said opening so as to be offset from said central longitudinal axis.

4. A film bridge assembly according to claim 1, further comprising first clamp located along one side of the film path and a second clamp located on a second opposing side of the film path, said first and second clamps being adapted to hold the cylindrical lens on the film bridge.

5. A film bridge assembly according to claim 4, wherein compliant material is provided respectively between each of said firs and second clamps and said cylindrical lens.

6. A film bridge assembly according to claim 4, further comprising a first pin which locates said first clamp on said first side of said film path, and a second pin which locates said second clamp on said second side of said film path, wherein each of said first and second pins are adapted to guide opposing edges of the film across the film bridge.

7. A method of scanning film comprising the steps of:
locating a first bridge member having a first film facing surface and a second bridge member having a second film facing surface relative to each other so as to define a slot there-between that provides for a passage of illumination light from an opening of said slot through film traveling across the film bridge along a film path;
providing a cylindrical lens on said opening so as to extend between the first film facing surface and the second film facing surface; and
transporting film to be scanned across said film bridge in manner in which the film contacts said cylindrical lens at or near an apex of the cylindrical lens and does not contact opposing edges of said cylindrical lens on each side of said apex.

8. A method according to claim 7, further comprising:
passing an illuminating light through said slot and said cylindrical lens so as to scan the transporting film.

9. A method according to claim 7, wherein said step of providing the cylindrical lens on said opening comprises centering said cylindrical lens on said opening.

10. A method according to claim 7, wherein said step of providing the cylindrical lens on said opening comprises providing said cylindrical lens in an offset manner on said opening.

11. A film bridge assembly for a film scanning system, the film bridge assembly comprising:
a first bridge member having a first film-facing surface;
a second bridge member having a second film facing surface, the first and second bridge members being spaced from each other to define a slot there-between that provides for a passage of illumination light from an opening of said slot through film traveling across the film bridge along a film path; and
a cylindrical part provided on one of said first or second film facing surfaces, such that said cylindrical part maintains a gap between film traveling across said cylindrical part and the opening from the slot.

12. A film bridge assembly according to claim 11, comprising a further cylindrical part, wherein said further cylindrical part is provided on the other of said first or second film facing surfaces.
